(19) United States
(12) Patent Application Publication
(10) Pub. No.: US 2012/0064300 A1
(43) Pub. Date: Mar. 15, 2012

(54) Carrier for a Silicon Block and Method for Producing Such a Carrier and Arrangement

(75) Inventors: Reinhard Huber, Freudenstadt/Dietersweiler (DE); Sven Worm, Schopfloch (DE)

(73) Assignee: Gebr. Schmid GmbH, Freudenstadt (DE)

(21) Appl. No.: 13/301,332

(22) Filed: Nov. 21, 2011

Related U.S. Application Data
(63) Continuation of application No. PCT/EP2010/056994, filed on May 20, 2010.

(30) Foreign Application Priority Data
May 22, 2009 (DE) 10 2009 023 122.6

(51) Int. Cl. B32B 3/30; B32B 5/02; B29C 47/00; B32B 7/04

(52) U.S. Cl. 428/167; 428/188; 428/156; 264/148

(57) ABSTRACT

A silicon block is firmly connected to a carrier for being moved together for further working by sawing, cleaning or the like. The carrier consists of plastic, for example of glass-fibre-reinforced plastic, and has in its interior a number of continuous longitudinal channels. These longitudinal channels are sawn into, and so cleaning fluid can then be introduced into the intermediate space between the sawn-up wafers in order to flush out sawing remains.

### CROSS-REFERENCE TO RELATED APPLICATIONS

This application is a continuation of PCT Application No. PCT/EP2010/056994, filed May 20, 2010, and claims priority to DE 10 2009 023 122.6 filed May 22, 2009, the disclosures of which are hereby incorporated by reference in their entirety.

### FIELD OF APPLICATION AND PRIOR ART

The invention is related to a carrier for a silicon block, a method for producing such a carrier and an arrangement of a silicon block on such a carrier.

It is known from U.S. 2011/070397 A1 to secure a silicon block for sawing into individual wafers to a carrier, in particular to firmly attach it thereto by adhesive bonding. Such a carrier is usually made of glass and is adhesively bonded to a further metal carrier. The metal carrier is then secured to a holding device or transporting device, in particular by screwing, for further handling, in particular also for sawing the silicon block into individual wafers, subsequent cleaning or the like.

### Problem and Solution

The invention addresses the problem of providing a carrier specified at the beginning, a method for the production thereof and an arrangement with which problems of the prior art can be avoided and with which it is possible in particular to produce the carrier at low cost and in a reliable process. Furthermore, it is intended to be adequately stable for a silicon block to be firmly attached to it by adhesive bonding for further processing thereof.

This problem is solved by a carrier with the features of claim 1, a method for producing such a carrier with the features of claim 13 and an arrangement with the features of claim 15. Advantageous and preferred refinements of the invention are the subject of the further claims and are explained in more detail below. Some of the features specified below are only described or enumerated for the carrier or the arrangement or only described or enumerated for the production method. However, irrespective of this, it is intended that they can apply both to the carrier itself and to the production method. The wording of the claims is made the content of the description by express reference.

It is provided that the carrier consists of plastic. According to the invention, it has in its interior at least one continuous longitudinal channel, advantageously a number of such longitudinal channels, which run parallel to one another and may be at the same distance from one another.

When the adhesively attached silicon block is sawn up into individual wafers, such longitudinal channels are also sawn into, and cleaning fluid can be introduced into them, emerging through the intermediate spaces between the wafers and thereby flushing out contaminants or the like such as so-called slurry. A good cleaning effect is possible in this way. Further advantages of such longitudinal channels in the interior of a carrier are known from DE 10 2009 023 121 A1, to which reference is explicitly made in this respect and the corresponding content of which is hereby made the content of the present description by express reference.

The advantage of plastic for the production of such a carrier, particularly also because of the longitudinal channels present in the interior thereof, lies in the way in which it allows production to be performed easily and in a reliable process, in particular by extrusion. Consequently, forms with internal channels or the like can also be produced, in particular also forms of any length or of a great length. A single carrier of an appropriate length can then be cut off. Furthermore, plastic is considerably less expensive than glass or ceramic material.

Furthermore, plastic has the great advantage that, after extrusion, the carrier can be processed relatively easily in a material-removing process, that is to say two-dimensionally. This advantageously takes place only by grinding or planing, which is possible relatively well in the case of plastic in comparison with other materials, such as glass or ceramic, which like plastic likewise undergo relatively small dimensional changes when they are subjected to temperature fluctuations.

In an advantageous refinement of the invention, the carrier consists of fibre-reinforced plastic to increase the stability and, in particular, also the dimensional stability when it is subjected to temperature fluctuations. Fibres from the group comprising glass fibre, carbon fibre, ceramic fibre and aramid fibre or other so-called high-tech fibres may be used for this. A proportion of such fibres may be, for example, at least 10%, preferably at least 25% or even more than 30%. Production of an elongated plastic carrier with fibre material can also be realized without any problem for a person skilled in the art by extrusion. Polyamide may be used, for example, as the plastic for the carrier. Further suitable plastics are likewise possible.

An underside of the carrier to which the silicon block is adhesively attached may have profilings or depressions, running in the longitudinal direction of the carrier, and elevations. These may serve for improving an adhesive bond with the silicon block. Such increases in the surface area, acting almost as it were as roughenings, serve for better adhesive bonding, both as a result of this and as a result of the possibility that adhesives can so to speak lock onto a microstructure. Profilings or depressions and elevations are advantageously formed uniformly or regularly on the underside and can be produced in a simple manner in the longitudinal direction during the extrusion. The height of such profilings should lie in the range of a few millimetres, in particular less than 1 mm, in order that, when the silicon block comes to lie against them, adhesive does not have to fill very large intermediate spaces. It may also be provided that the working of the carrier, in particular on its underside in the way described above, leaves behind a still adequate surface roughness.

On its upper side, facing away from the silicon block, the carrier may have at least one longitudinal groove. This may be formed as an undercut longitudinal groove. The longitudinal groove may accommodate at least one threaded element, which has a thread for screwed securement to a holding device or transporting device described above.

As an alternative to such possibilities for securement in grooves on the upper side of the carrier, bores may be provided in the carrier, in particular in the upper side thereof. Means for connecting to a holding device, for example threaded bores for screwing in screws for securement to the holding device, may also be incorporated in said carrier, possibly even self-tapping screws may be screwed into cylindrical bores, which improves or reduces the effort involved in producing the carriers, which are used only once and disposed of after sawing a silicon block adhesively attached to them.

These and other features emerge not only from the claims but also from the description and the drawings, where the individual features can be realized in each case by themselves or as a plurality in the form of subcombinations in an embodiment of the invention and in other fields and can constitute advantageous and inherently protectable embodiments for which protection is claimed here. The subdivision of the application into individual sections and subheadings does not restrict the general validity of the statements made thereunder.

### BRIEF DESCRIPTION OF THE DRAWINGS

Exemplary embodiments of the invention are illustrated schematically in the drawings and are explained in greater detail below. In the drawings:

FIG. 1 shows a sectional view through a carrier according to the invention with a number of longitudinal channels, each of a different cross section, and with grooves on the upper side and

FIG. 2 shows the underside of the carrier greatly enlarged.

### DETAILED DESCRIPTION OF THE EXEMPLARY EMBODIMENTS

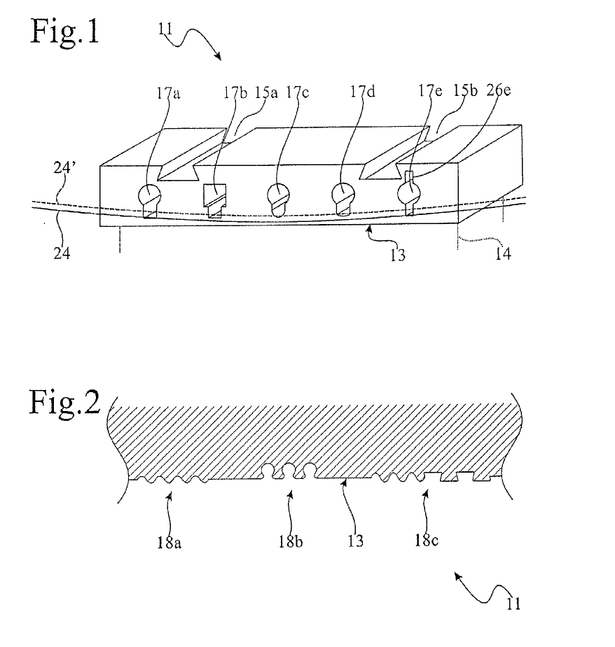

FIG. 1 illustrates a carrier 11 according to the invention, which is formed as an elongated flat panel and to the underside 13 of which a silicon block 14, represented by dashed lines, is secured or firmly attached by adhesive bonding. The carrier 11 has a length of, for example, approximately 600 mm to 800 mm, a width of approximately 200 mm and a thickness of approximately 20 mm to 30 mm. It consists of plastic and is produced by extrusion. The plastic is polyamide and is fibre-reinforced with glass fibre, for example with a proportion of approximately 30%.

Provided in the interior of the carrier 11 are five longitudinal channels 17a to 17e. They pass through the entire length of the carrier with a cross section that remains the same in each case. They are at the same time straight and parallel to one another, and advantageously, but not necessarily, also at a distance from one another that remains approximately the same. During production of the carrier 11, the longitudinal channels 17 are likewise produced by extrusion, by appropriate formation of the extrusion die or template. With respect to the formation of the longitudinal channels, reference is made to the German patent application DE 10 2009 023 121 A1l , the content of which in this respect is hereby made the content of the present description by express reference. Extrusion of the plastic allows the shown cross-sectional form of the carrier to be produced particularly easily. In practice, all of the longitudinal channels 17 advantageously have the same cross section.

Furthermore, two undercut grooves 15a and 15b are also provided on the upper side for securement, as a kind of dovetailed guide or the like for threaded elements that are displaceable therein. With respect to the formation of the groove, reference is made to the German patent application DE 10 2009 023 119 A1, the content of which in this respect is hereby made the content of the present description by express reference. As an alternative to the grooves 15, bores could be provided, for example already with an internal thread, which serve for screwing the carrier in a way similar to threaded elements in the grooves.

FIG. 1 also illustrates how the silicon block 15 has been cut through as far as into the carrier 11 by a sawing wire 24, which is present in multiple form parallel to a sawing device, not represented any more specifically. Such a sawing-in depth is represented by dashed lines as sawing wire 24′. Here, the usual, slightly bent form of the sawing wire 24 or 24′ can be seen, it also being possible for the bending to be less.

FIG. 2 shows a great enlargement of the underside 13 of the carrier 11, in order to illustrate the aforementioned profilings or depressions and elevations in three different regions. These serve for improving an adhesive bond with the silicon block 14, for which purpose they are advantageously provided in each case uniformly or regularly and over the entire width of the underside 13 of the carrier.

The left-hand profilings 18a are formed as alternating depressions and elevations, for example with a height of at most 1 mm or significantly less. The depressions are approximately the same size as the elevations, but may also be of a different size.

The middle profilings 18b are formed as depressions, to be precise undercut. This allows the adhesive for the silicon block to lock on, so to speak, or bond particularly well.

The right-hand profilings 18c are formed as alternating depressions and elevations, to be precise respectively undercut. This allows the effect of the two aforementioned profilings to be advantageously combined as it were for further improved adhesive bonding.

Like the grooves 15 or the longitudinal channels 17, it is easily possible for the profilings to be produced during the extrusion. In order to surface-grind the underside 13 to a plane, in order that it can come to lie well against a silicon block, the profilings may be formed as raised somewhat more than is actually desired in the end for the adhesive bonding, so that an adequate profiling for the desired effect still remains after the grinding away of some material height.

1. A carrier for a silicon block, said silicon block being firmly connected to the carrier and moved together with the latter for working by sawing, cleaning or the like, the carrier consisting of plastic, wherein the carrier has in its interior at least one continuous longitudinal channel.

2. The carrier according to claim 1, wherein said carrier consists of fibre-reinforced plastic.

3. The carrier according to claim 2, being reinforced with fibres from a group comprising: glass fibre, carbon fibre, ceramic fibre and aramid fibre.

4. The carrier according to claim 2, wherein a proportion of said fibres is at least 10%.

5. Carrier according to claim 4, wherein a proportion of said fibres is at least 25% to 30%.

6. The carrier according to claim 1, wherein an underside of said carrier for adhesive bonding to a silicon block has profilings or depressions together with elevations running along in longitudinal direction of said carrier to improve an adhesive bond with said silicon block.

7. The carrier according to claim 6, wherein said carrier has uniform or regular profilings.

8. The carrier according to claim 1, wherein said carrier has on an upper side, facing away from said silicon block, at least one longitudinal groove for accommodating at least one threaded element with a thread for screwed securement to a holding device or transporting device.

9. The carrier according to claim 8, wherein said longitudinal groove is an undercut longitudinal groove.

10. The carrier according to claim 1, wherein bores for means for connecting to a holding device are provided on an upper side of said carrier.

11. The carrier according to claim 10, wherein said bores are threaded bores for engagement of screws connected to said holding device.

12. The carrier according to claim 1, wherein said plastic is polyamide.

13. A method for producing a carrier according to claim 1, wherein said carrier is produced by extrusion as a very long piece or as a continuous piece, wherein single carriers are cut to length from said piece.

14. The method according to claim 13, wherein, after extrusion, said carrier is only worked in a material-removing process two-dimensionally, or by grinding or planing.

15. An arrangement of a carrier according to claim 1 with a silicon block, wherein said silicon block is firmly connected to said carrier with adhesive means.

16. The arrangement according to claim 15, wherein said silicon block is firmly connected to an underside of said carrier.
